(19) United States
(12) Patent Application Publication
(10) Pub. No.: US 2009/0125977 A1
(43) Pub. Date: May 14, 2009

(54) LANGUAGE FRAMEWORK AND INFRASTRUCTURE FOR SAFE AND COMPOSABLE APPLICATIONS

(75) Inventors: Ajay Chander, San Francisco, CA (US); Jeffrey Fischer, Sunnyvale, CA (US); Hiroshi Inamura, Cupertino, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: DOCOMO Communications Laboratories USA, Inc., Palo Alto, CA (US)

(21) Appl. No.: 12/252,229

(22) Filed: Oct. 15, 2008

Related U.S. Application Data
(60) Provisional application No. 60/984,266, filed on Oct. 31, 2007.

(51) Int. Cl. G06F 9/46; G06F 21/00

(52) U.S. Cl. 726/1; 719/313

(57) ABSTRACT

A method and apparatus is disclosed herein for using a language framework for composable programs. In one embodiment, the method comprises accessing active content having a software component embedded therein, where the software component has a plurality of components that together implement a work flow of a sequence of activities, the plurality of components representing one or more external services, one or more user interface controls and one or more inputs and output; executing the software component, including mediating communication between components using an information flow-based security model.

### PRIORITY

The present patent application claims priority to and incorporates by reference the corresponding provisional patent application Ser. No. 60/984,266, titled, “Language Framework and Infrastructure for Safe and Composable Applications,” filed on Oct. 31, 2007.

### FIELD OF THE INVENTION

The present invention relates to the field of computer software and its creation; more particularly, the present invention is related to software components that can be composed in a provably safe way, and that provide the ability to interact with their environment, which may consist of web services, devices, or other applications and components.

### BACKGROUND

Modern computing tasks by end-users involve the frequent use of off-the-shelf applications and web services, often interconnected with each other by sharing their computation results and user preferences. In order to carry out these tasks, users have to customize each of these applications by hand, and enable sharing of computation results through some version of the cut-and-paste operation. The problem is exacerbated on small form factor devices like mobile phones, where such frequent user manipulation is costly.

A large part of the usability challenge comes from the difficulty in navigating between and within applications or websites that act as front-ends to web services. For example, consider a scenario where a user wants to schedule a movie outing via her mobile phone. To do so, she might look up which movies are playing, read movie reviews for a subset, pick a movie and showtime, buy the tickets, add an entry for the movie to her calendar, and email the details to her friend. Each of those six actions might involve several clicks or entries at a website. She might very well lose patience and give up on the exercise altogether. This usability challenge affects the viability of such applications and services themselves, as users find it difficult to integrate them towards the decisions of daily life, such as those related to planning, consumption, and communication.

Two recent categories of applications demonstrate qualities that can be used to improve user experience. Mashups combine multiple web applications into a single user interface (UI), correlating content from the constituent applications. For example, packagemapper.com superimposes the route taken by a user's package on a Google Map. This combines Google Maps with package tracking services from FedEx and UPS, along with a Yahoo service which converts addresses to latitude/longitude coordinates.

Widgets or gadgets are small mini-applications that can be embedded into a larger web page or downloaded to a mobile phone. These applications usually provide a simple interface to a subset of an external website (e.g., BBC News, Wikipedia, Facebook, etc.). They can be customized by a user through a page of settings or parameters. In addition, most widget framework providers offer a website to facilitate the creation, sharing, and adapting of widgets.

Unfortunately, both mashups and widgets suffer from security issues that limit the types of applications deployed using these approaches. To be useful, mashups and widgets must have the user's access rights to the underlying applications they rely on for content. However, the user has no control over what the mashup/widget does with those rights. For example, it could: perform other actions on the underlying sites, such as deleting the user's content, pass the user's private data to a third party site (although this could be prevented using a same-origin security policy), or in the case of mashups, pass the user's private data from one of the mashup sites to another.

Finally, existing software development platforms, especially for mobile users, don't address these basic issues either. Developers wishing to target mobile users currently have two primary options for application platforms: native platforms, such as various versions of Java and BREW, or web browsers. Native platforms provide access to the device's hardware, but have poor external connectivity support and low level APIs. Browsers provide a high level programming model and easy connectivity, but have no access to a device's hardware. More seriously, browser-based applications frequently have security vulnerabilities, such as cross-site scripting (XSS), cross-site request forgery (CSRF), and session fixation.

### SUMMARY OF THE INVENTION

A method and apparatus is disclosed herein for using a language framework for composable programs. In one embodiment, the method comprises accessing active content having at least one software component embedded therein, where the at least one software component has a plurality of components that together implement a work flow of a sequence of activities, the plurality of components representing one or more external services, one or more user interface controls and one or more inputs and output; executing the software component, including mediating communication between components using an information flow-based security model.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a flow diagram of one embodiment of a process for performing the monent.

FIG. 2A illustrates one embodiment of a movie monent.

FIG. 2B illustrates connections between elements of one embodiment of a movie monent.

FIG. 3 illustrates the information flow graph for a monent.

FIG. 4 illustrates relationships between tag lattice elements

FIG. 5 is a flow diagram of one embodiment of a compilation process.

FIG. 6 illustrates a movie monent.

FIG. 7 illustrates an example of denied rights.

FIG. 8 is a block diagram of one embodiment of a computer system.

### DETAILED DESCRIPTION OF THE PRESENT INVENTION

A new class of software application components, referred to herein as monents (mobile components), are described. In one embodiment, monents provide user interfaces to external services. They can be customized through settings—persistent parameters adjustable by the end user. In one embodiment, monents can correlate data from multiple websites/services. Monents provide simple end-user composition where data is exchanged through shared settings and services. Thus, monents correlate data from multiple websites/services without custom programming.

Monents are built on a security model, which includes reasoning about information flow, and controls access to external services and a monent's environment (other monents and the local hardware). In one embodiment, the policies enforced by this model are user-driven and managed through a tagging mechanism. For purposes herein, tags are labels that represent a user's categorization of people and services based on their level of trust and what they are willing to share with each tagee.

In one embodiment, two or more monents are combined using matching rules that require no user intervention. The result of the composition operation is guaranteed to be a valid monent, with the same operational behavior and capabilities as a monent assembled by directly combining its constituent elements. Also, if a collection of monents individually obey a security policy, then the composition of these monents also obeys the security policy.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### Overview

Monents are software components that include user interfaces to external services. In one embodiment, they are customized through settings—persistent parameters adjustable by the end user. Monents provide simple end-user composition where data is exchanged through shared settings and services.

In one embodiment, monents are built on an information flow security model that controls access to external services and a monent's environment (e.g., other monents and the local hardware). In one embodiment, the security policies enforced by the security model are user-driven and managed through a tagging mechanism.

Two or more monents can be combined using matching rules which require no user intervention. In one embodiment, this composition operation has two key properties: compositional closure and sound composition. Compositional closure requires that a monent composed from other monents has the same operational behavior and capabilities as a monent assembled by directly combining its constituent elements. As for a sound composition, if a collection of monents are individually sound with respect to the security policy, then the composition of these monents is also sound.

One embodiment of a monent framework is described. The monent framework includes a compiler, a composer, runtime infrastructure, and a server-side monent sharing application. The compiler accepts a high level description of a monent's services, settings, and UI components. From these, the compiler generates an Adobe Flash™ application. The composer accepts the source descriptions of two or more monents and creates a combined monent, which then may be compiled or composed further.

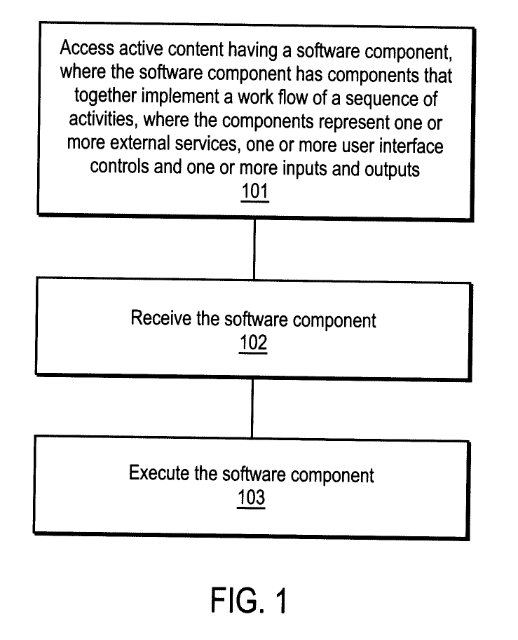

The composed monent may subsequently be executed. FIG. 1 is a flow diagram of one embodiment of a process for performing the monent. The process is performed by processing logic that may comprise hardware (circuitry, dedicated logic, etc.), software (such as is run on a general purpose computer system or a dedicated machine), or a combination of both.

Referring to FIG. 1, the process begins by processing logic accessing active content having a software component (processing block 101). For purposes herein, active content may be any data type into which a monent may be embedded, including, but not limited to text (e.g., IM, email, etc), HTML (e.g., web pages, HTML email, etc.), documents (e.g., spreadsheets, presentations, etc.), Flash, etc. In one embodiment, the software component has components that together implement a work flow of a sequence of activities, where the components represent one or more external services, one or more user interface controls and one or more inputs and outputs. In one embodiment, the software component is linked to one or more other software components implicitly by name and data type. In one embodiment, the software component communicates with the one or more other software components by shared settings and services.

In one embodiment, the components of the software component comprise customizable wrappers around services; categorized settings for communicating data to other software components; and a user interface layer for customizable user interaction, and communication between components is specified declaratively. In one embodiment, the settings and services facilitate interacting with external locations under control of a security manager. In one embodiment, the security manager decides whether to activate a software component by evaluating information flow between inputs and outputs using a security policy that characterizes data sources and sinks according to user defined labeling.

In one embodiment, components in the plurality of components are declaratively interconnected. In one embodiment, the components combine data from a plurality of external sources. These external sources may include an application like Microsoft Outlook, a browser, services like, for example, GPS location services, other device sensors, etc. In one embodiment, the service is a callable entity that provides content. In one embodiment, the callable entity comprises a website.

In one embodiment, communication between components occurs via settings. In one embodiment, the settings include key-value pairs, and each setting is an input, an output or an internal data for the software component or data internal to a component. In one embodiment, an input obtains data from a user directly, from other software components, or from an environment, and further wherein each output or internal setting obtains values from services or user interface controls from within the software component.

In one embodiment, the user interface controls communication with remote services.

In one embodiment, creating the software component comprises receiving all software component services and settings; building a list of one or more rights that the software component requires for its operation, where the rights include at least one of a right to read an input setting and a right to call a service; and evaluating whether to grant each of the one or more rights based on the list of rights, an information flow graph of the software component and an environment. In one embodiment, evaluating whether to grant each right is based on information flow analysis. In one embodiment, evaluating whether to grant each right comprises building a graph at compilation time showing links between inputs and outputs by building a direct information flow graph, converting the direct information flow graph into a transitive information flow graph, and storing the transitive information flow graph in the software component. In another embodiment, the graph showing links between inputs and outputs is built at run time. In one embodiment, the information flow graph is externalized by the individual components, i.e., it is visible externally even if the internals of the individual component may not be in certain environments. This information flow graph may be constructed by hand for trusted components or computed via a static or dynamic analysis of the component. The framework then computes the transitive information flow graph, by computing the transitive closure of the individual information flow graphs. By externalizing the information flow graph, the individual components can be reused in different environments with different security policies.

After the software component has been created, processing logic subsequently receives the software component (processing block 102). The processing logic may be part of a mobile device or other remotely located device or a client or any other device capable of executing the software component.

After being received, processing logic executes the software component (processing block 103). This includes mediating communication between components using an information flow annotation-based security model.

In one embodiment, the annotation-based security model is a tag-based security model. In one embodiment, the security model is enforced with a security manager, such that the security manager mediates the communication between components. In such a case, in one embodiment, the process also includes the security manager controlling interactions with an external location and enforcing a user-defined security policy that controls information flow. In one embodiment, enforcing a user-defined security policy is performed by the security manager when the software component is activated. In one embodiment, the security policy assigns tags to the inputs and outputs which characterize data according to its sensitivity. In one embodiment, the user specifies the security policy by manually applying tags to services and settings.

### Elements of a Monent

In one embodiment, the elements of monents include settings, services, and user interface (UI) components.

### Settings

Settings are used to facilitate communication within and between monents. In one embodiment, settings are implemented using key/value pairs. In one embodiment, each setting is either an input, an output, or internal to the monent. Input settings can obtain their values from direct user input, other monents, or the environment. The environment is a collection of settings representing information available from the local device (e.g., location information, personal information, etc.) or enclosing application context (e.g., bookmarks, email recipients, etc.).

Output and internal settings obtain their values from services or UI components within the monent. In one embodiment, the values of output settings are made available to other monents.

### Services

A service represents a callable entity that provides content for a monent. This may include external websites, web services, or device features (hardware or applications) that have been wrapped in a service interface. Like websites, a service is identified through its URL. We divide this URL into two portions: a location, which is evaluated by the security policy, followed by a query, which contain data specific to a particular request. The result of a service call is structured content, such as XML, HTML, or JSON.

### UI Components

The user interface components provided for monent developers are designed to allow the quick implementation of simple front-ends to external content. In one embodiment, the supported components include labels, buttons, text input boxes, and data grids (which display record-like content from a service). Since the form factor for a mobile device is small, in one embodiment, a tabbed navigation is used to segment the content. Tabs are strictly a user interface artifact—they do not restrict the correlation of UI components displayed in different tabs. However, in one embodiment, each UI component belongs to a single tab.

These elements may be better understood through an example.

In the following example, a movie scenario is described. A user wishes to employ several websites in a quest to setup a movie outing. For the example, Google's Movie website (google.com/movies), the Internet Movie Database (imdb.com), and MovieTickets.com will be used. The movie tickets site requires her credit card. In order for the user to trust the monent, the user must be confident that the site is not malicious and that the monent will not pass their credit card number to the other websites. In addition, the user must be confident that the monent will not spam everyone in her address book.

The monent should also address usability issues. Context can be used to economize the user's interactions. For example, when displaying a listing of theaters, the monent can use knowledge of the user's location to display relevant results. Once the user selects a theater and movie at one website, the user should not have to re-select the theater and movie at each subsequent site.

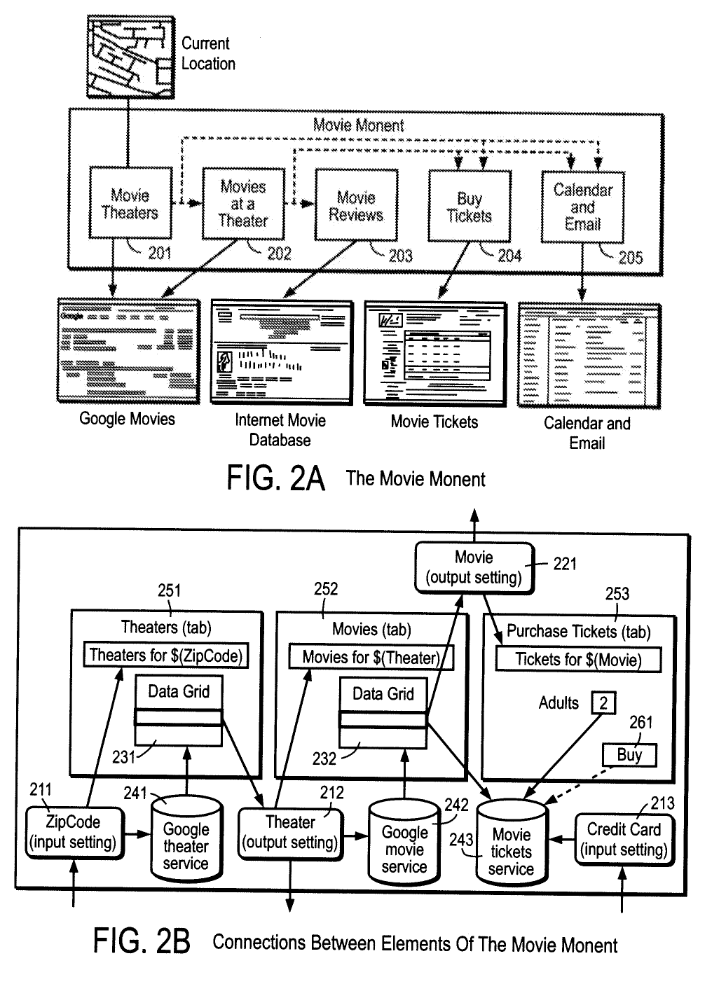

FIG. 2A illustrates an embodiment of a movie monent. Referring to FIG. 2A, each square represents a step, or sub-application, involved setting up the movie outing and corresponds to an interaction with a website or service. Due to limited space on the display, only one step is shown at a time. In one embodiment, navigation between sub-applications is accomplished using a tab metaphor in which each sub-application has a tab at the top of the display and selecting that sub-application's tab causes it to be displayed.

Solid arrows in FIG. 2A represent the links between sub-applications and external services. Dashed arrows represent the passing of context between sub-applications. The selected movie theater from sub-application 201 is passed to the movie selection sub-application 202, ticket purchase sub-application 204, and calendar/email sub-application 205. The selected movie and showtime is passed to the movie review sub-application 203, ticket purchase sub-application 204, and calendar/email sub-application 205.

In the movie example described above, settings for the current location (e.g. a zip code or latitude/longitude), the selected theater/movie/showtime, and the user's credit card information are used. Also, each external website is represented as a service, along with the user's email application, with each website for the movie monent given a separate tab.

### Connecting Monent Elements

In one embodiment, the elements of a monent are interconnected in a declarative style. Settings can obtain their values from the selected record in a data grid or from by extracting a value from the result of a service call. In one embodiment, extracting a value from the result of a service call is performed using an XPath-like notation. Likewise, UI components can obtain their values from settings, services, and other UI Components. For example, if the user's zip code is an input setting, then a label might include the value of this setting as follows: Current movies for zipcode ${ZipCode}. The ${ZipCode} string is replaced with the value of the ZIPCODE setting.

In one embodiment, the location and query of a service are parameterized by settings or values from UI components, using a similar template notation. For example, a service that calls Google Movies to obtain the listings for a specific zip code might use a location of google.com/movies and a query of ?near=${ZipCode}. When making the request, the service first replaces the ${ZipCode} string with the value of the ZIPCODE setting and then concatenates the location and query to obtain a URL. Thus, given a zipcode of 94304, the service sends a request to google.com/movies?near=94304.

FIG. 2B shows element interconnections for the subset of one embodiment of a movie monent that interacts with Google. Referring to FIG. 2B, arrows are used to show the flow of data between elements. ZIPCODE setting 211 is used by GOOGLE THEATER service 241 and by a label on THEATERS tab 251. The results from GOOGLE THEATER service 241 are then displayed by a data grid 231 on the same tab, THEATERS tab 251. In one embodiment, each record displays the name and address of a particular theater. The selected theater's name is stored in THEATER output setting 212. THEATER output setting 212 is used by GOOGLE MOVIE service 242 to build a second query, which retrieves movies playing at the specified theater. In addition, THEATER output setting is included in a label on MOVIES tab 252. The results returned by GOOGLE MOVIE service 242 are displayed using a second data grid 232. The name of the selected movie is output via MOVIE output setting 221.

The details of the selected movie are passed to MOVIE TICKETS service 243, along with the quantity to be purchased, which is input from PURCHASE TICKETS tab 253. The credit card number for the purchase is passed from an input setting 213 to MOVIE TICKETS service 243.

In one embodiment, MOVIE TICKETS service 243 is not actually called until the user presses “Buy” button 261.

### Responding to Changes

If the user happens to change ZIPCODE input setting 211 or the selected theater, the change is reflected in the monent as well. The monent framework described herein assumes that any setting, service result, or record selection may change. To address this, the monent compiler tracks the dependences between monent elements and automatically generates the event-driven code to refresh dependent elements when a change occurs. For, example, if the user selects a different theater, THEATER setting 212 is changed and the selected movie invalidated.

In some situations (e.g., making a purchase), a monent is constructed in which a service request is not initiated without explicit input from the user. To address this situation, a button control in the UI may be connected to a service. If a button is connected to the service, the call is not initiated until the button is pressed and the service has valid inputs.

### A Security Model

In one embodiment, monents interact with the external (potentially unsafe) world through settings and services. In one embodiment, with a high level model, monents cannot deny service through the UI or by consuming too much CPU. Thus, the primary security issues are these interactions with the outside world. To address them, each monent is run in a logical sandbox, and all its external interactions are controlled. This is performed by a monent infrastructure component referred to herein as the security manager. In one embodiment, the security manager is shared code that is included in the monent definition by the monent compiler. In another embodiment, the security manager is software that is shipped on the mobile device (e.g., as a library or as a part of the operating system).

### Rights

The ability to perform an external interaction is represented as a right. In one model, two types of rights are tracked: the right to read an input setting and the right to call a service's location (and thus read its result). When a monent starts, the security manager reviews all the monent's services and settings and builds a list of rights that the monent will need for its operation. The list of requested rights, an information flow graph of the monent, and the monent's current environment are all used to evaluate whether the rights can be granted. In making this determination, the security manager queries a policy component, which returns tags for each service. In one embodiment, the security policy takes as inputs a list of settings and service URLs and maps them to lists of tags. In one embodiment, the policy manager is a database storing preconfigured tags for each setting and URL. The result of the query is an all-or-nothing decision. In one embodiment, if the set of rights cannot be granted together, then the monent is disabled and an appropriate error message is presented to the user, explaining which rights could not be granted.

Service locations may contain settings, which may be changed after a monent has been started. Thus, the set of rights required by the monent may also change. To address this, the security manager tracks which settings are used in service locations. In one embodiment, if one of these settings changes, a new set of required rights is constructed and evaluated; otherwise, if the new set cannot be granted, the monent is disabled, and feedback provided indicating that the setting change caused the security issue.

### Information Flow

In one embodiment, the security manager decides whether to grant a set of rights based on an information flow analysis. This analysis looks at the possible destinations of each input and determines whether those destinations are allowed by the security policy.

To enable the information flow analysis, a graph G=(V,E) is built at compilation time, showing the (transitive) links between the monent's inputs and outputs. The inputs of a monent include its input settings and the responses from service calls. The outputs of a monent are its output settings and service parameters.

In one embodiment, the graph is built as follows. First, a direct information flow graph is built that has a vertex for each setting and UI component. For each service, two vertices are created: one for the outbound request and one for the response. Input vertices are labeled with I and output vertices are labeled with O. Edges are created as follows:
1. If a service uses a setting as a template parameter in its location or query, an edge is added from the setting to the service's request vertex.
2. If a setting takes its value from the response of a service call, an edge is added from the service's response vertex to the setting.
3. If a UI component takes its value from the response of a service call, an edge is added from the service's response vertex to the UI component's vertex.
4. If a UI component takes its value from a setting, an edge is added from the setting to the UI component.
5. If a setting takes its value from a UI component, an edge is added from the UI component to the setting.

Next, the direct information flow graph is converted into a transitive information flow graph using a series of operations. First, the transitive closure of all edges is taken: if then are edges A→B and B→C, an edge A→C is added. Then, any vertices not labeled with I or O are dropped along with any edges which start or end at such vertices. Finally, edges between vertices labeled O are also dropped. The resulting transitive information flow graph is stored in the monent and made available for the monent to use at runtime.

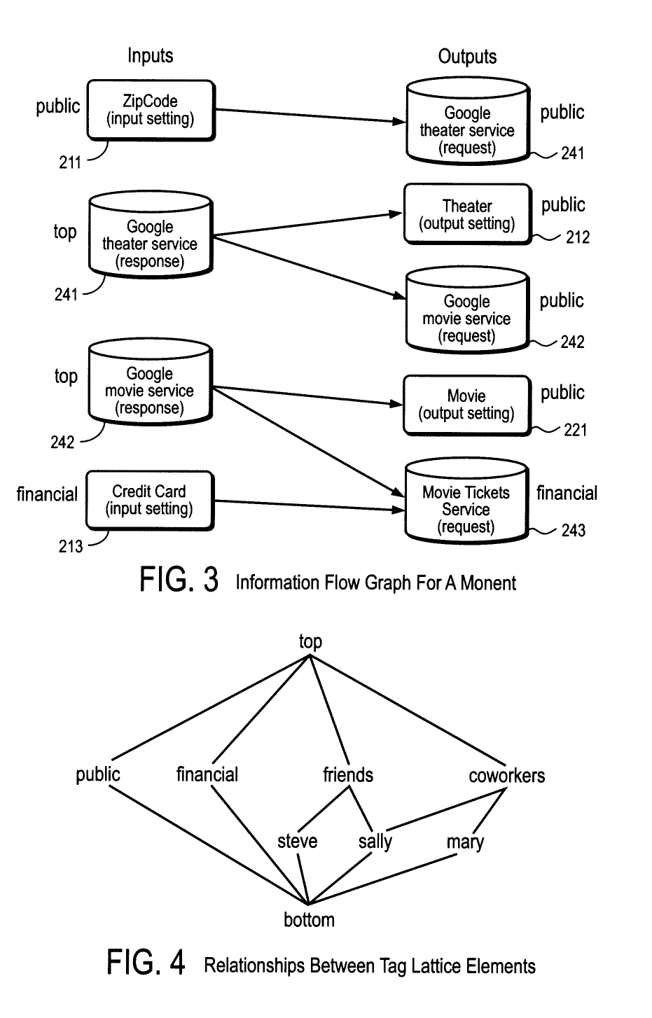

FIG. 3 shows the information flow graph for the monent connections depicted in FIG. 2B. Referring to FIG. 3, the two Google services each have two nodes, one for requests and one for responses. The two edges starting at the GOOGLE THEATER service 241 response are indirect—they pass through the THEATERS data grid component 231, which was dropped from the graph. The (redundant) link from THEATER output setting 212 and the GOOGLE MOVIE request was also dropped.

MOVIE TICKETS service 243 has only an input node, as it does not return any data, only a status response. CREDIT CARD setting 213 has only one outbound edge, connecting it to MOVIE TICKETS service 243. Therefore, the credit card number is not passed to any of the other websites.

### Tags

The information flow analysis has shown that the user's credit card number will not be passed to other websites. However, how do we know that we can trust the movie ticket site itself? Also, the user might not feel comfortable giving their zip code out to any random site on the web. How do we know whether we can trust the other websites? These are security policy decisions. To evaluate these decisions, in one embodiment, inputs and outputs are labeled with tag sets. A tag represents a category of services and people and, implicitly, a category of the user's data. Given a tag set T, we write ∥T∥ to mean the underlying categories the tag set represents. Given an input I which flows into outputs O₁ . . . On, the security manager ensures that:

∥U_{j=1 . . . n}(T_{O}_{ⱼ})∥ [symbol] ∥T₁∥

In other words, all outputs that flow from an input must have categories represented in the input tag set. If this can be guaranteed, the monent is considered to be sound with respect to its tag labeling. If this cannot be guaranteed, the security manager does not grant any rights to the monent.

The actual labeling of inputs and outputs is done by a security policy. This is a separate component from the security manager and will be discussed in more detail below.

### The Tag Lattice

Rather than enumerate all possible categories for an input or output, in one embodiment, individual tags represent sets of categories. To do this, a lattice (i.e., a partial ordering) of tags, referred to herein as θ is defined. The tag top represents the set of all possible categories and the tag bottom represents the empty set. Other tags, which may be defined by the user or by the security policy, fall in between these two tags in the partial ordering. For example, the security policy may use the tag financial for sensitive financial information. The binary predicate [symbol] returns true for θ₁ [symbol] θ₂ if θ₁ is equal to θ₂ or appears before θ₂ in the partial order established by the lattice. The lattice obeys the following identities, where θ, θ₁, and θ₂ are arbitrary lattice elements from θ:

θ [symbol] top=true

bottom [symbol] θ=true

θ [symbol] θ=true

FIG. 3 illustrates an example of relationships between tag lattice elements. Referring to FIG. 3, the vertices in the graph have been labeled (by a security policy) with tags. The inputs of GOOGLE THEATER service 241 and GOOGLE MOVIE service 242 have been labeled as public, meaning that the monent creator (user) is willing to trust them with some non-identifying personal information (e.g., the zip code). No restrictions are placed on the responses from these services and thus they are labeled with top. MOVIE TICKETS service 243 is trusted with the credit card information and thus it is labeled with financial. All the settings, except for CREDIT CARD 213, have been labeled public.

To evaluate whether to grant rights to this monent, the security manager compares the tags associated with the source and target of each edge. If, for each edge, the target tag is [symbol] the source edge, then the monent is sound. In this case, the following comparisons are obtained:

public [symbol] public Theater service request

public [symbol] top Theater service response

public [symbol] top Movie service request

public [symbol] top Movie setting

financial [symbol] top Ticket service request

financial [symbol] financial Ticket service request

All of these comparisons are true, and thus the monent is sound with respect to this labeling.

### Tagging Contacts

In one embodiment, in addition to facilitating interactions with external websites, tags facilitate interactions with a user's friends and colleagues. To do this, the user's contact list is incorporated into the tag lattice. Each contact becomes an element of the lattice. In addition, users can label each contact with additional tags to indicate the membership of that contact in specific categories. For example, one might have tags such as friends or coworkers. If a contact is labeled with one of these categorization tags, the contact's associated lattice element appears before the category in the tag lattice ordering. For example, if sally and steve are tagged with friends, then sally [symbol] friends and steve [symbol] friends. FIG. 4 shows the relationship between lattice elements if Steve is tagged with friends, Mary is tagged with coworkers, and Sally is tagged with friends and coworkers.

### The Tag Set Lattice

Security policies can label inputs and outputs with sets of tags. This is particularly useful when referring to a set of people (e.g., mary, sally, steve). To accommodate this in the information flow analysis, the tag lattice is extended to tag sets. Each element θₛₑₜ of this lattice is a set of tags, with the greatest element T={top} and the least element ⊥={bottom}. We define our element ordering operator [symbol] in terms of the single tag lattice comparison operator ≡ as follows:

$${T}_{1} {⊑}_{set} {T}_{2} = \{ \begin{matrix} true if ∀ {θ}_{1} ∈ {T}_{1} \cdot ∃ {θ}_{2} ∈ {T}_{2} \vert {θ}_{1} ⊑ {θ}_{2} \\ false otherwise\end{matrix}$$

In other words, for tag set T₁ to be less than or equal to tag set T₂, each element of T₁ must be dominated by or equal to an element in T₂.

In one embodiment, elements of the tag set lattice may contain redundant information. For example, given tags t₁ and t₂ such that t₁ [symbol] t₂, then the tag set lattice elements {t₂} and {t₁, t₂} are equivalent with respect to [symbol] . To avoid redundant representations of tag sets, we define the function norm: θₛₑₜ→θₛₑₜ, which returns a non-redundant representation of any set lattice element:

$$norm ( T ) = ⋃ ( ∀ {θ}_{1} , {θ}_{2} ∈ T \cdot \{ \begin{matrix}\{ {θ}_{2} \} \\ \{ {θ}_{1} \} \\ \{ {θ}_{1} , {θ}_{2} \}\end{matrix} \begin{matrix}if {θ}_{1} ⊑ {θ}_{2} \\ if {θ}_{2} ⊑ {θ}_{1} \\ otherwise\end{matrix} )$$

Given the tag set lattice, the requirements for a monent to be sound may be stated. The output of the security policy is referred to herein as a tag environment, which labels the inputs and outputs of a monent with elements from the tag set lattice.

Definition 1 (Soundness) Given a monent M with input set I, output set O and information flow graph Gₘ=(Vₘ,Eₘ), M is sound with respect to a tag environment E: I∪O→Θₛₑₜ, if and only if ∀(i→o)εEₘ, E[o] [symbol] E[i].

In other words, for each edge in the graph, the output tag set must be equal to or less than the input tag set.

### Security Policies

The creation of a tag environment for a monent is done by a security policy. In one embodiment, this is purposely kept separate from the security manager to enable the use of different policies. A few possible mechanisms for implementing a security policy may be used. In one embodiment, a security policy is implemented by having users manually apply tags to services and settings. This gives them the most control over the operation of their monents. In another embodiment, a security policy is implemented by having one or more external reputation services return tags for services based on whitelisting and/or blacklisting. In yet another embodiment, a security policy is implemented by having services return their own tags, which are cryptographically signed by an third-party, trusted authority. In still another embodiment, a security policy is implemented by having a rule based policy language could be used to determine tags, based on a combination of the above approaches. Note that all of these can be used alone or in combination with each other.

In one embodiment, a combination of the first and second approaches is used: users define their own tags for settings and services are labeled by a reputation service. Settings defined by the environment have unchangeable tags determined by the system. An environment setting is only made available to a monent if the monent's label for the setting is compatible, per the [symbol] relation.

### Tag Polymorphism

One may wish to apply a tag to a service based on the specific query made by that service. For example, when sending/receiving messages for a specific contact, it is useful to have the associated service be labeled with the contact's tag. In one embodiment, this is accomplished by including the contact as a part of the service's location (e.g., the URL might be like mail.org/myemail/steve). The security policy can then extract the name from the request and return it as the service's tag. This is referred to as tag polymorphism, after the label polymorphism introduced in A. Myers, et al., “A Decentralized Model for Information Flow Control,” in SOSP '97, pgs. 129-142, ACM Press, 1997.

### Monent Composition

In one embodiment, several smaller monents are built and are combined to create a larger monent. This is done through a compose operation. For example, each tab of the movie monent of FIG. 2A could be implemented as a separate monent. If monents are small and general enough, they can be reused in new contexts. For example, there are a number of possibilities for reuse of components in the movie monent described above. First, if the user prefers to use another website to select movies, monents to select movies from that site may be built and then used with the existing movie review and ticket purchase monents. Second, the calendar monent could be used with any other monents providing a date, time and location. Third, a map and directions monent could be composed with the movie monent to provide directions to the theater.

### Implicit Linking

In one embodiment, composition is accomplished using implicit linking. This enables users to compose their own monents, including composing them on mobile devices where simple UI actions are required.

In one embodiment, the constituent elements of source monents are linked implicitly, by name and datatype. For example, if one monent provides a THEATER output setting of type string and another monent provides a THEATER input setting of type string, these settings are merged in the composite monent. Thus, shared settings and services become the communication mechanisms between monents. In one embodiment, in the event that two monents have incompatible settings or services (e.g., the same name but different data types), the appropriate components are kept separate and renamed to avoid a conflict.

In one embodiment, the individual UT components of the source monents are not linked directly. Since monent user interfaces are organized by tabbed navigation, user interfaces can be combined by simply taking the union of the individual tab sets.

### Static Versus Dynamic Composition

A set of monents can be composed statically, at compile time, or dynamically, at runtime. In one embodiment, static composition is used, as it does not require a dynamic linking mechanism or runtime loading of code. However, dynamic composition of monents may be used as well.

### Composition Rules

There are a number of rules that are used to compose a monent from other monents.

### Merging Settings

In one embodiment, to compose monents, the settings from all the source monents are first merged into a single output set. Algorithm 1 below shows one embodiment of a process for merging the settings from all source monents into a first output set. In one embodiment, if using static composition, the monent compiler performs the process for merging settings. In another embodiment, if using dynamic composition, the process for merging settings is performed at runtime by software running on the mobile device. Referring to Algorithm 1, the algorithm takes as its input the set of source monents [symbol] , where each monent Mε [symbol] has a collection of settings M.settings, and returns Settings, a mapping from setting names in the composite monent to their definitions, and NameMapₛₑₜ, a mapping from setting names in the original source monents (prefixed by their monent name) to the corresponding names in the target monent.

Each setting is examined to see whether it should be added directly to the target monent, renamed, or merged with another setting. If a setting with this name has not been seen before, it is added directly to the output set (possibly to be merged later). If the setting is internal (internal settings are kept private) or incompatible with an existing setting of the same name in the output set, the new setting is added with a new name, created by prefixing the original name with the source monent's name. Finally, if there is a compatible (same datatype, not both outputs) monent in the output set with the same name, the two are merged. If a source monent's input setting can be provided by another monent's output setting, the two are merged into an output setting.

Algorithm 1 merge_settings

```
input source monents [symbol]
Settings ← empty_map
NameMapₛₑₜ ← empty_map
for all M ∈ [symbol] do
  for all S ∈ M.settings do
    n = S.name
    n′ ← M.name +′.′+ n
    if S.direction = internal or
    (n ∈ Settings.keys and
      (S.datatype ≠ Settings [n] .datatype or
      S.direction = Settings [n] .direction = output)) then
        // Add setting to output with prefixed name
        Settings[n′] ← {S with name = n′}
        NameMapₛₑₜ[n′] ← n′
    else
      if n ∈ Settings.keys and
        S.direction = internal then
        // Use old setting
        NameMapₛₑₜ[n′] ← n
      else
        // Add setting to output
        Settings[n] ← S
        NameMapₛₑₜ[n′] ← n
      end if
    end if
    end for
end for
return Settings, NameMapₛₑₜ
```

Merging Services

In one embodiment, services are merged in a similar manner. Algorithm 2 below illustrates a process for merging services. Referring to Algorithm 2, each service of each source monent is examined and compared to any other services with the same name. Two services are combined if they match in name, location, and query, where combined means that two service definitions are equivalent and only one is used in the composite monent. In such a case, any references to the other service in the original (non-composed) moments are renamed to the service definition that is used in the composite monent. In addition, they both must not be connected to triggering buttons in the user interface. Conflicts between two services of the same name are resolved by renaming one of the services. The results of this process are Services, a map from target service name to the target service definitions, and NameMap_{svc}, a map from (prefixed) source service names to target service names. Target service definitions are the definitions used in the composite monent.

Algorithm 2 merge_services

```
input source monents [symbol]
Services ← empty_map
NameMap_{svc} ← empty_map
for all M ∈ [symbol] do
  for all S ∈ M.services do
    n = S.name
    n′ ← M.name +′.′+ n
    if n ∈ Settings.keys then
      S′ ← Services[n]
      if S.location = S′.location and
        S.query = S′.query and
        not (has_button(S) and has_button(S′)) then
        // Merge these services
        NameMap_{svc}[n′] ← n
      else
        // Add service to output with prefixed name
        Services[n′] ← {S with name = n′}
        NameMap_{svc}[n′] ← n′
      end if
    else
      // First service with this name, add to output
      Services[n] ← S
      NameMap_{svc}[n′] ← n
    end if
  end for
end for
return Services, NameMap_{svc}
```

### Merging UI Components

In one embodiment, UI components are merged by prefixing each component's name with the name of its source monent. These renamed components can then be combined into a single set without conflicts.

### Resolving Element References

After the settings, services, and UI components of the source monents have been combined using the algorithms above, any references between them are resolved. In one embodiment, this is done using NameMapset (created using algorithm 1) and NameMapsvc (created using algorithm 2). These two data structures are mappings from setting/service names, prefixed with their source monent, to the names which will be used for the associated setting/service in the composed monent.

If a referenced setting or service is mapped by NameMap_set or NameMap_svc to a name prefixed by its source monent, this name is used in the referencing element. This indicates that the setting or service is not shared with those of any other source monents. If a referenced setting or service is mapped to its original name (with no prefix), this original name is kept in the reference. All references to UI components are changed to reference prefixed names (e.g., if there is a reference in monent m1 to UI component “MovieLabel”, this will become “m1.MovieLabel” in the composed monent).

### Properties of Composition

In one embodiment, if a monent is built by composing smaller monents, it behaves no differently from a monolithic monent built directly from the underlying settings, services, and UI components. This property is referred to herein as compositional closure. This is shown to be true by demonstrating two simpler properties. First, a monent can be partitioned and then composed to yield a monent equivalent to the original. Second, with a minor exception, monents can be composed in any order, resulting in equivalent monents.

### Monent Equivalence

First, the equivalence of monents is defined based on graph isomorphism. Two monents M₁ and M₂ are isomorphic if a bijection β can be constructed between the elements of M₁ and the elements of M₂ such that, for each pair (e₁, e₂)εβ of linked elements:
1. e₁ and e₂ are of the same element type (setting, service, or UI component) and have the same internal properties (e.g. datatype, direction).
2. For each link from e₁ to another element e′₁ of M₁, there is a corresponding link from e₂ to e′₂ of M₂ such that (e′₁, e′₂)εβ.

### Monent Partitioning and Composition

In one embodiment, a monent M containing at least two UT tabs can be arbitrarily partition into two independent monents M₁ and M₂ as follows:
Given that M has a set of tabs T, place a subset of these tabs T₁ in monent M₁ and the remaining tabs T\T₁ in M₂. Each UT component is placed in the same monent as its associated tab.
If a service's response is consumed by a UI component, it is placed in the same monent as that component. If the response is consumed by multiple UI components, the service is added to both monents. The remaining services are divided arbitrarily between the monents.
Input settings are placed in all monents which consume their values. Output and internal settings are placed in the monent containing the service or UI component which produces their value. If the value of an output or internal setting is produced in one monent but used in the other, the setting is added as an input to the monent in which it was used. If the source setting was internal, it is promoted to be an output.

As long as the necessary inputs are provided, monents M₁ and M₂ can function independently. If monents M₁ and M₂ are composed into a single monent M′, then M′ and M are isomorphic.

### Composition Ordering

In one embodiment, given an ordered list of monents M=[M₁, M₂, . . . Mₙ], these monents in 2ⁿ⁻¹ can be composed in different ways while still preserving the original ordering. For example, [M₁, M₂, M₃] can be composed into a single monent as either M₁+M₂+M₃, (M₁+M₂)+M₃, or M₁+(M₂+M₃). Each of those compositions will be isomorphic to all the other compositions. Compositions of the monents in an arbitrary ordering will also be isomorphic, if no two monents have a setting with the same output name and datatype that is used by a third monent as an input. In that case, the choice of which output is used by the other monents is dependent on the order in which the monents are composed. If one of the conflicting outputs is renamed before composition to avoid this conflict, order independence is restored.

### Sound Composition

Another property of the composition algorithm described herein is sound composition: if a collection of monents M₁, M₂, . . . Mₙ are individually sound with respect to a tag environment E, then the composition of these monents M′ is also sound.

This may be shown to be true by looking at the transitive information flow graph G_{m′} for M′. A mapping M is defined from each vertex V of M′ to a set of vertices V in the source monents such that there is at most one vertex in v from each source monent and all vertices in v∪{V} are labeled with the same tag set. Furthermore, each edge (V₁→V₂)εG_{m′} has a corresponding edge (Vᵢ₁, Vᵢ₂)εGᵢ in the graph of a source monent Mᵢ such that Vᵢ₁εM[V₁] and Vᵢ₂εM [V₂]. Thus, tagset(V₁)=tagset(Vᵢ₁) and tagset(V₂)=tagset(Vᵢ₂). Since each of the source monents are sound, we know that tagset(Vᵢ₂) [symbol] (Vᵢ₁). Thus, tagset(V₂) [symbol] tagset(V₁) is true for each edge in G_{m′} and the composed monent is sound with respect to E.

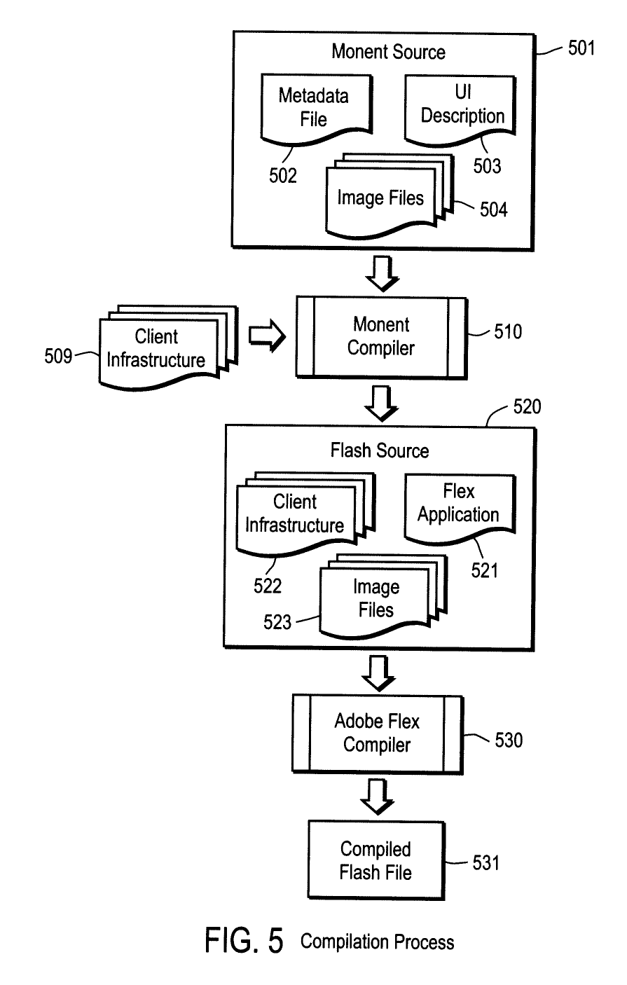

One embodiment of our monent framework has been prototyped using the Adobe Flash player as a target platform. FIG. 5 is a flow diagram of one embodiment of a compilation process that shows how monents are compiled. The process is performed by processing logic that may comprise hardware (circuitry, dedicated logic, etc.), software (such as is run on a general purpose computer system or a dedicated machine), or a combination of both. Referring to FIG. 5, a monent 501 is specified in two files: a metadata file 502, which describes the settings and services used by monent 501, and a UI description file 503, which describes the monent's UI components. In one embodiment, UI description file 503 uses a subset of Adobe's Flex XML language (without any embedded code). This allows the UI to be built using Adobe's visual designer. In addition, image files 504 may be included in the monent. Settings, services, and UI components may reference each other as described above.

Monent compiler 510 compiles monent source 501 to produce a flash source 520.

Once completed, the monent is translated into an Adobe Flex™ application 521. Each setting and service becomes an object in this application, and event-driven code is added to refresh/invalidate objects based on downstream data changes. Client-side infrastructure 522, including the security manager, is implemented in ActionScript (Adobe's version of JavaScript for the Flash player) and copied into the monent. An extra tab called settings is added to each monent, to enable users to change the values of the monent's input settings.

Next, Adobe's Flex compiler 530 is run to create a compiled Flash file 531. This compiled file can be executed by any Flash player, typically as a browser plug-in.

Note that in one embodiment, a separate program implements monent composition. It takes as its inputs an arbitrary number of monent source definitions. These are combined into a single output definition using the approach described above. The resulting monent can then be compiled as described above.

### The Movie Monent

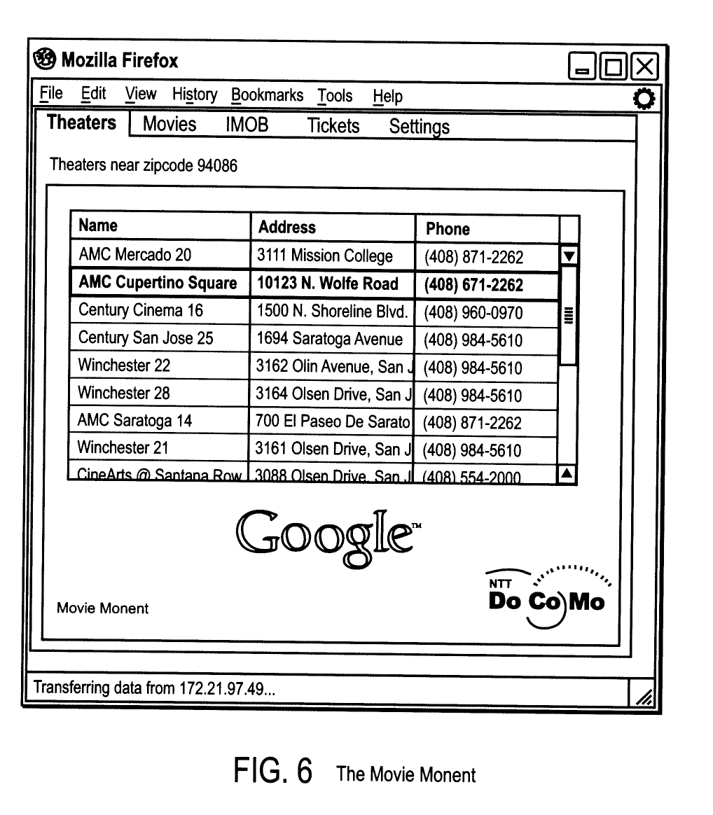

In one embodiment of the framework described herein, a subset of the movie monent was generated, including reading live data from Google Movies and the Internet Movie Database. This is shown in FIG. 6. Referring to FIG. 6, tickets are purchased by calling a simulated e-commerce web service. In one embodiment of extracting the relevant content from these websites, a separate proxy server extracts the appropriate content using XSLT and Java and then returns an XML document to the monent.

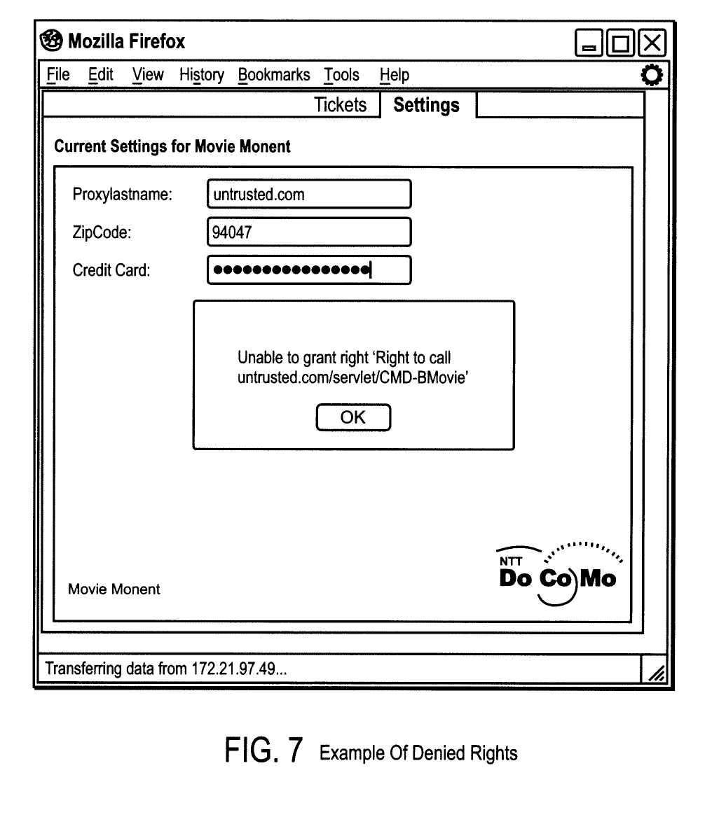

In one embodiment, the hostname of the proxy service is an input setting for the monent. This setting is part of the location for each service which uses the proxy. Thus, when the proxy is changed, the security policy is automatically reevaluated to see whether the monent can use that proxy. If the security check fails, the monent is disabled, except for the settings tab. FIG. 7 shows any example where the user tried to set the proxy as untrusted.com, which was denied by the security policy. In such a case, a window is displayed indicating that a right could not be granted by the security manager.

### A Monent Sharing Application

In one embodiment, monents can be shared, configured, and composed using a web-based application. A list of available monents is maintained in the application's database and displayed as a selection of icons for the user. A user can choose to run, configure, or compose a monent. Running a monent causes the associated Flash file to be downloaded to the user's browser. Users can edit values and tags for a monent's settings (these are local to each user). Finally, a user can select two or more monents for composition. This causes the composer and compiler to be run on the server generating a new monent. This new monent is then made available on the sharing application.

### An Example of a Computer System

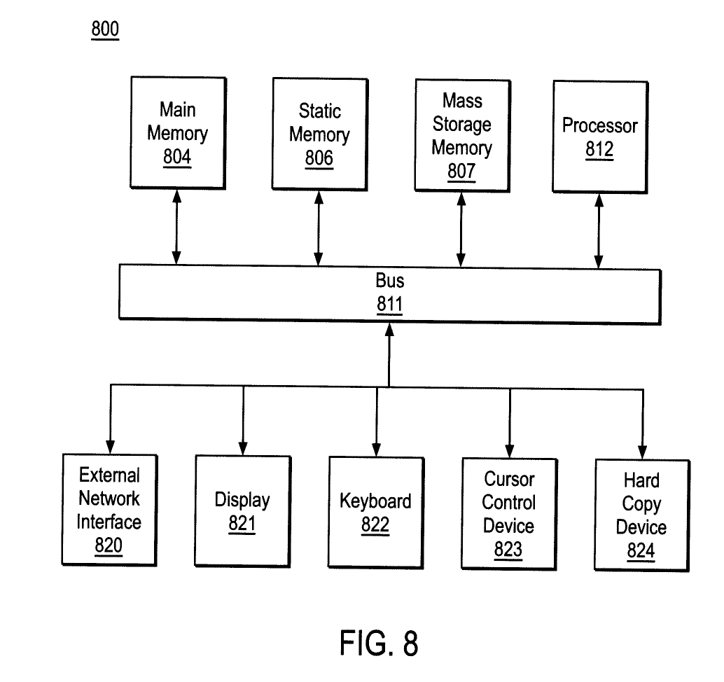

FIG. 8 is a block diagram of an exemplary computer system that may perform one or more of the operations described herein. Referring to FIG. 8, computer system 800 may comprise an exemplary client or server computer system. Computer system 800 comprises a communication mechanism or bus 811 for communicating information, and a processor 812 coupled with bus 811 for processing information. Processor 812 includes a microprocessor, but is not limited to a microprocessor, such as, for example, Pentium™, PowerPC™, Alpha™, etc.

System 800 further comprises a random access memory (RAM), or other dynamic storage device 804 (referred to as main memory) coupled to bus 811 for storing information and instructions to be executed by processor 812. Main memory 804 also may be used for storing temporary variables or other intermediate information during execution of instructions by processor 812.

Computer system 800 also comprises a read only memory (ROM) and/or other static storage device 806 coupled to bus 811 for storing static information and instructions for processor 812, and a data storage device 807, such as a magnetic disk or optical disk and its corresponding disk drive. Data storage device 807 is coupled to bus 811 for storing information and instructions.

Computer system 800 may further be coupled to a display device 821, such as a cathode ray tube (CRT) or liquid crystal display (LCD), coupled to bus 811 for displaying information to a computer user. An alphanumeric input device 822, including alphanumeric and other keys, may also be coupled to bus 811 for communicating information and command selections to processor 812. An additional user input device is cursor control 823, such as a mouse, trackball, trackpad, stylus, or cursor direction keys, coupled to bus 811 for communicating direction information and command selections to processor 812, and for controlling cursor movement on display 821.

Another device that may be coupled to bus 811 is hard copy device 824, which may be used for marking information on a medium such as paper, film, or similar types of media. Another device that may be coupled to bus 811 is a wired/wireless communication capability 825 to communication to a phone or handheld palm device.

Note that any or all of the components of system 800 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
accessing active content having at least one software component embedded therein, where each software component has a plurality of components that together implement a work flow of a sequence of activities, the plurality of components representing one or more external services, one or more user interface controls and one or more inputs and outputs; and
executing the software component, including mediating communication between components using an information flow-based security model.

2. The method defined in claim 1 wherein the security model is enforced with a security manager, such that the security manager mediates the communication between components.

3. The method defined in claim 2 further comprising the security manager controlling interactions with an external location and enforcing a user-defined security policy that controls information flow.

4. The method defined in claim 3 wherein enforcing a user-defined security policy is performed by the security manager when the software component is activated.

5. The method defined in claim 1 wherein the annotation-based security model is a tag-based security model.

6. The method defined in claim 1 wherein components in the plurality of components are declaratively interconnected.

7. The method defined in claim 6 wherein the components combine data from a plurality of external sources.

8. The method defined in claim 7 wherein the plurality of external sources comprises one selected from a group consisting of a website, a mail program, a browser, a service, and a sensor.

9. The method defined in claim 1 wherein the service is a callable entity that provides content.

10. The method defined in claim 9 wherein the callable entity comprises a website.

11. The method defined in claim 1 wherein communication between components occurs via settings.

12. The method defined in claim 11 wherein the settings include key-value pairs.

13. The method defined in claim 11 wherein each setting is an input, an output or an internal data for the software component or data internal to a component.

14. The method defined in claim 1 wherein an input obtains data from a user directly, from other software components, or from an environment, and further wherein each output or internal setting obtains values from services or user interface controls from within the software component.

15. The method defined in claim 1 wherein the user interface controls communication with remote services.

16. The method defined in claim 1 further comprising:
tracking connection dependencies between components in the software component; and
automatically generating event-driven code to change dependent components when a change occurs in any setting, service result or user selection.

17. The method defined in claim 1 further comprising defining an information flow interface for each component in the software component, wherein information flow interface describes said each component as a collection of inputs and outputs and an information flow relationship between the inputs and outputs.

18. The method defined in claim 1 wherein the security policy assigns tags to the inputs and outputs which characterize data according to its intended recipients.

19. The method defined in claim 18 wherein the user specifies the security policy by manually applying tags to services and settings.

20. The method defined in claim 1 wherein the software component is linked to one or more other software components implicitly by name and data type.

21. The method defined in claim 20 wherein the software component communicates with the one or more other software components by shared settings and services.

22. The method defined in claim 1 further comprising:
receiving all software component services and settings;
building a list of one or more rights that the software component requires for its operation, the rights including at least one of a right to read an input setting and a right to call a service; and
evaluating whether to grant each of the one or more rights based on the list of rights, an information flow graph of the software component and an environment.

23. The method defined in claim 22 wherein evaluating whether to grant each right is based on information flow analysis.

24. The method defined in claim 23 wherein evaluating whether to grant each right comprises:
building a graph at compilation time showing links between inputs and outputs by
building a direct information flow graph;
converting the direct information flow graph into a transitive information flow graph; and
storing the transitive information flow graph in the software component.

25. The method defined in claim 1 further comprising applying different annotations to externalized versions of an information flow graph of one software component, such that the one software component can be reused in different environments with different security policies.

26. The method defined in claim 1 wherein the components of the software component comprise:
customizable wrappers around services;
a plurality of categorized settings for communicating data to other software components; and
a user interface layer for customizable user interaction, wherein communication between components is specified declaratively.

27. The method defined in claim 26 wherein settings and services facilitate interacting with external locations under control of a security manager.

28. The method defined in 26 wherein the security manager decides whether to activate a software component by evaluating information flow between inputs and outputs using a security policy that characterizes data sources and sinks according to user defined labeling.

29. The method defined in claim 1 wherein the information flow graphs of the individual monents are manually or automatically computed.

30. An article of manufacture having one or more computer readable storage media storing instructions thereon which, when executed by a system, cause the system to perform a method comprising:
accessing active content having at least one software component embedded therein, where each software component has a plurality of components that together implement a work flow of a sequence of activities, the plurality of components representing one or more external services, one or more user interface controls and one or more inputs and outputs; and
executing the software component, including mediating communication between components using an information flow-based security model.

31. A method comprising:
accessing a plurality of software components that each have a plurality of components that together implement a work flow of a sequence of activities, the plurality of components representing one or more external services, one or more user interface controls and one or more inputs and outputs, and wherein each of the software components are sound; and
performing a composition operation on the plurality of software components to create a single software component that is guaranteed to be sound.
